(19) United States
(12) Patent Application Publication
(10) Pub. No.: US 2007/0105499 A1
(43) Pub. Date: May 10, 2007

(54) METHOD FOR EXECUTING PROGRAM USING BLUETOOTH APPARATUS

(75) Inventors: Chen Ko, Taipei City (TW); Chung-Jen Huang, Taipei City (TW); Chi-Yuan Chen, Taipei City (TW); Chih-Shin Lan, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SYNAGE TECHNOLOGY CORPORATION, Taipei City (TW)

(21) Appl. No.: 11/464,497

(22) Filed: Aug. 15, 2006

(30) Foreign Application Priority Data
Nov. 8, 2005 (TW) 94139056

(51) Int. Cl. H04B 7/00

(52) U.S. Cl. 455/41.2

(57) ABSTRACT

The executing program method is applied to a Bluetooth dongle using a universal serial bus (USB) as its transmission interface. When the Bluetooth dongle is plugged in an electronic device, the electronic device will automatically detect the Bluetooth dongle. An application which is stored in a storage unit of the Bluetooth dongle is activated, and the Bluetooth dongle is also activated to link a Bluetooth device. The cache files produced by the application are pointed to store in the storage unit of the Bluetooth dongle. In addition, an auto-detecting program is executed to detect whether the Bluetooth dongle is removed or not every certain period. If the Bluetooth dongle was removed, the link from the Bluetooth dongle to the Bluetooth device will be terminated. The cache files in the Bluetooth dongle will be cleared. Finally, the application and the auto-detecting program are closed.

### CROSS-REFERENCE TO RELATED APPLICATION

This application claims the priority benefit of Taiwan application serial no. 94139056, filed Nov. 8, 2005. All disclosure of the Taiwan application is incorporated herein by reference.

### BACKGROUND OF THE INVENTION

1. Field of the Invention

The present invention generally relates to a method of executing programs using a Bluetooth apparatus. More specifically, the present invention relates to a method of executing programs using a USB Bluetooth dongle.

2. Description of Related Art

The Bluetooth is a short-distance, low-cost wireless communication technology using a Frequency-Hopping Spread Spectrum (FHSS) method to reduce the interference. The data is transferred between the master/slave devices using a Time Division Duplex method, and the baud rate can be up to 1 Mbps, and the transmitting range ranges from 10 to 100 meters. Since the Bluetooth is characterized with these advantages, therefore in recent years many wired electronic devices have been gradually developed to wireless Bluetooth devices, such as Bluetooth earphones, Bluetooth microphones, Bluetooth mice and keyboards. And these Bluetooth devices can communicate with electronic devices such as computers, cellular phones, personal organizers and intellectual home electric appliances. Moreover, a Bluetooth dongle can be attached to demodulate the Bluetooth signals and to send/receive the Bluetooth signals.

FIG. 1 is a schematic system block diagram of conventionally conducting a voice over IP (VOIP) communication using the Bluetooth earphone and the Bluetooth microphone. FIG. 1 includes a Bluetooth dongle 100, a Bluetooth earphone and a microphone 130, and a computer 120 with internet access. The computer 120 has a storage unit 110, and is installed with a VOIP application.

When a user wants to conduct a voice conversation over the internet using the Bluetooth earphone and the microphone 130, the user first plugs the Bluetooth dongle 100 in the computer 120, and the computer 120 detects the Bluetooth dongle 100. Next, the user issues a command to execute the VOIP application to activate the VOIP function. If the computer 120 haven't installed with the VOIP application, the use has to install and execute the program, such that the VOIP function can be activated. While the VOIP application is running, the cache files are stored in the storage unit 110 of the computer 120. During the execution of the VOIP application, if the user needs to send/receive files with the VOIP user on the other end, the files also have to be stored in the storage unit 110 of the computer 120.

As described above, the communication using Bluetooth device has the following disadvantages.

1. After the user plugs the Bluetooth device in the computer, the application has to be manually executed.

2. If there is no application installed in the computer, the user has to install the application.

3. If the computer is a public computer, the cache files will be left in the public computer when the application is executing, and when the user needs to send/receive files, the data will also be stored in the public computer.

### SUMMARY OF THE INVENTION

Therefore, an object of the present invention is to provide a method of executing programs using a Bluetooth device. An application is stored in the Bluetooth dongle, and when the Bluetooth dongle is plugged in and unplugged, the application is executed and closed automatically. Thus the plug-and-play can be realized, and the additional steps of installing and removing the application can be omitted.

The present invention provides a method of executing application using a Bluetooth device, which is suitable for use in the Bluetooth dongle with a USB plug. When the Bluetooth dongle is plugged into the USB port of an electronic device, the electronic device detects the Bluetooth dongle automatically, and the application stored in the storage unit of the Bluetooth dongle is executed. Meanwhile, the Bluetooth dongle is activated to link to the Bluetooth device. The cache files created by the application are pointed to the storage unit of the Bluetooth dongle, and the auto-detecting program is started to detect whether the Bluetooth dongle is removed in every time period. If the Bluetooth dongle is removed, the link to the Bluetooth device is disconnected, the cache files stored in the storage unit of the Bluetooth dongle are removed, and the application and the auto-detecting program are terminated.

According to an embodiment of the present invention, after the application is started, the conversation via the Bluetooth device is conducted; and after the Bluetooth dongle is removed, the conversation is terminated.

According to an embodiment of the present invention, the application includes a VOIP and an Instant Messenger (IM) application.

According to an embodiment of the present invention, the Bluetooth device includes a Bluetooth voice device, a Bluetooth video device or a Bluetooth input device.

According to an embodiment of the present invention, the Bluetooth voice device includes a Bluetooth earphone and a Bluetooth microphone.

According to an embodiment of the present invention, the Bluetooth input device includes a Bluetooth keyboard, a Bluetooth mouse or a Bluetooth personal digital organizer.

According to an embodiment of the present invention, when the application needs to access the files, the storage unit in the Bluetooth dongle is used to access the files.

According to an embodiment of the present invention, the electronic device includes a computer device, an intellectual home appliance or a personal digital organizer.

According to an embodiment of the present invention, the application is coded using a Green Software.

According to an embodiment of the present invention, the unit period includes one second.

According to an embodiment of the present invention, the storage unit includes a hard drive or a memory.

Since the present invention adopts the method of executing the built-in application automatically after the Bluetooth device is plugged in, and the application is coded using the green software, therefore users can directly start the network communication using the Bluetooth device without manually installing and executing any program, and there will be no record left in other electronic devices.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1 is a schematic system block diagram of conventionally conducting a VOIP communication using the Bluetooth earphone and microphone.

FIG. 2 is a schematic block diagram of the Bluetooth dongle system according to an embodiment of the present invention.

FIG. 3 is a schematic flowchart of the method of executing the program using the Bluetooth device according to an embodiment of the present invention.

FIG. 4 is a schematic block diagram of the Bluetooth dongle system according to an embodiment of the present invention.

FIG. 5 is a schematic flowchart of the method of conducting the VOIP communication using the Bluetooth earphone and the microphone according to an embodiment of the present invention.

FIG. 6 is a schematic block diagram of the Bluetooth dongle system according to an embodiment of the present invention.

FIG. 7 is a schematic flowchart of the method of conducting the real-time communication using the Bluetooth keyboard and the mouse according to an embodiment of the present invention.

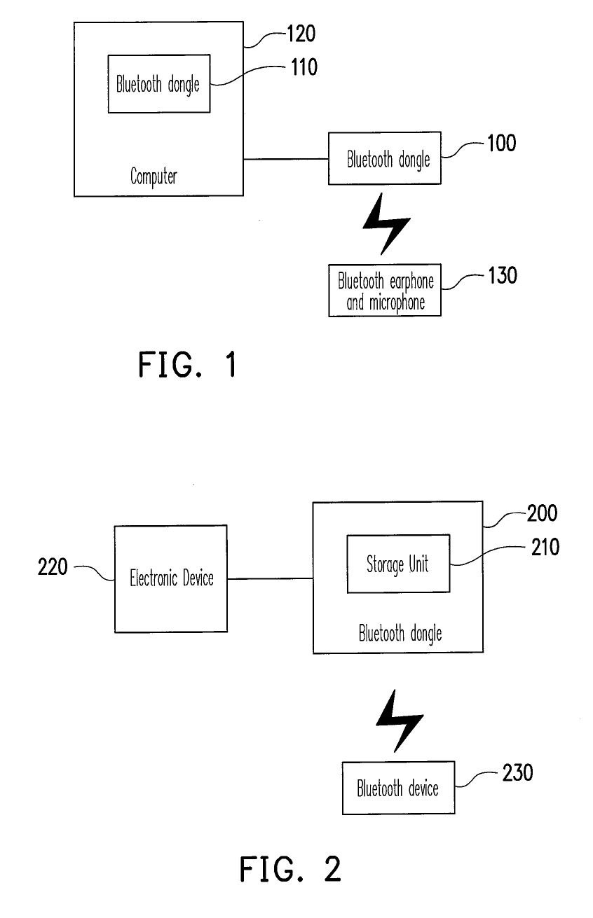

### DESCRIPTION OF EMBODIMENTS

FIG. 2 is a schematic block diagram of the Bluetooth dongle system according to an embodiment of the present invention. Referring to FIG. 2, the present embodiment includes a Bluetooth dongle 200, a Bluetooth device 230, and an electronic device 220. The storage unit 210 in the Bluetooth dongle 200 of the present embodiment stores an application and an auto-detecting program. The Bluetooth device 230, for example, is a Bluetooth earphone, a Bluetooth microphone, a Bluetooth mouse, a Bluetooth keyboard, a Bluetooth personal digital organizer, or other Bluetooth video device, etc. The electronic device 220, for example, is a computer, an intellectual home electric appliance, or a personal digital organizer. The storage unit 210, for example, is a flash memory, a hard drive, a read only memory (ROM), or a Direct Memory Access (DMA) memory. However those skilled in the art would appreciate that the present invention is not limited to such hardware combinations.

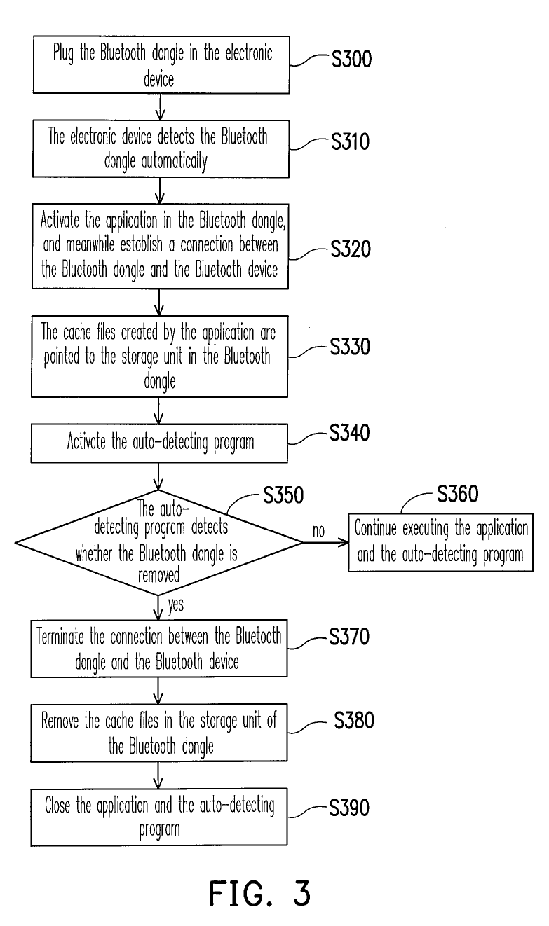

FIG. 3 is a schematic flow chart of the method of executing program using the Bluetooth device according to an embodiment of the present invention. Referring to FIG. 2 and FIG. 3, the method of executing program using the Bluetooth device is described below.

First, a user plugs the Bluetooth dongle 200 in a USB port or other transmission port of the electronic device 220 (Step S300). The electronic device 220 automatically detects the Bluetooth dongle 200 (Step S310). Then, the application stored in the Bluetooth dongle 200 is activated. In the mean time, a wireless connection between the Bluetooth dongle 200 and the Bluetooth device 230 is also established (Step S320). The cache files created during the execution of the application are pre-pointed to the storage unit 210 in the Bluetooth dongle 200 (Step S330). The application, for example, is a VOIP application or an IM program coded using the Green Software. The application is automatically executed after the Bluetooth dongle 200 is plugged in the electronic device 220 without manual installation and removal. Besides, there is no record left in the electronic device 220 after the Bluetooth dongle 200 is removed.

Next, the auto-detecting program stored in the Bluetooth dongle 200 is activated (Step S340) to detect whether the Bluetooth dongle 200 is removed in every unit time period (Step S350). The unit time period can be set to one second, but not limited to it. After the application is activated, the user can begin the communication through the Bluetooth device 230 until the Bluetooth dongle 200 is removed. When there is a need to sent/receive files while the application is running, the files can be accessed through the storage unit 210 in the Bluetooth dongle 200.

If the auto-detecting program detects that the Bluetooth dongle 200 has not been removed, then the application and the auto-detecting program will be continuously executed (Step S360). If the auto-detecting program detects that the Bluetooth dongle 200 has been removed, then the connection between the Bluetooth dongle 200 and the Bluetooth device 230 will be terminated (Step S370), and the cache files in the storage unit 210 in the Bluetooth dongle 200 will be removed (Step S380). Finally, the application and the auto-detecting program are closed (Step S390).

Accordingly, compare to the conventional technology, in the present invention the user can directly activate the application without installing or executing any application manually, and the cache files created during the application execution will not be left in the electronic device, which is very convenient for the public computer users.

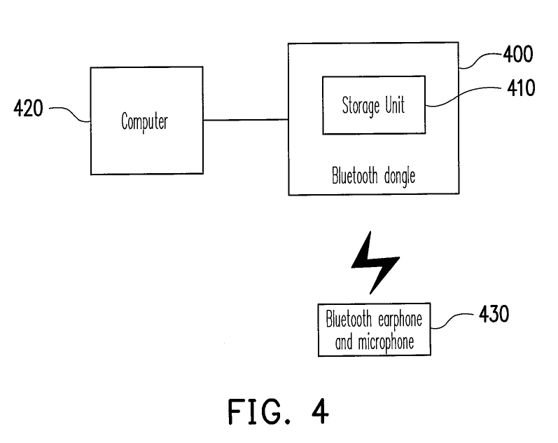

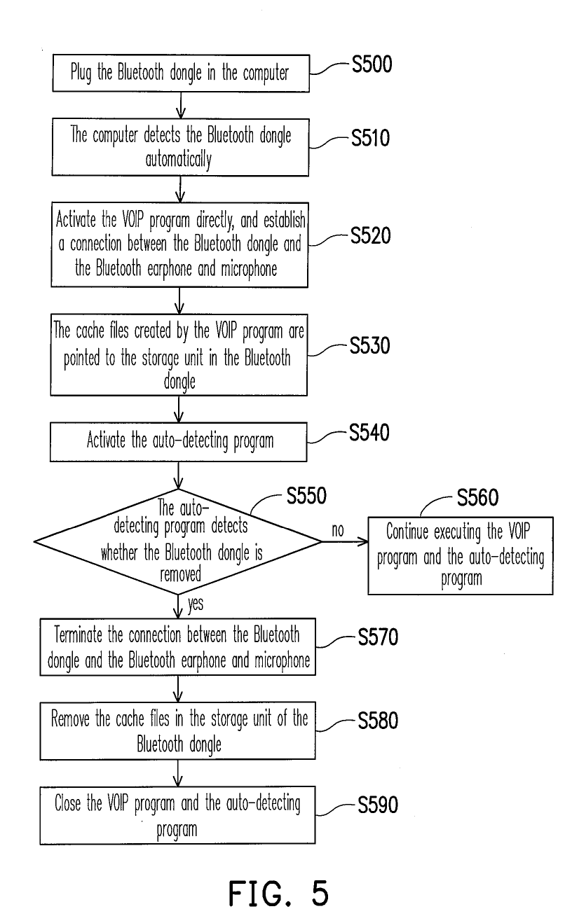

FIG. 4 is a schematic block diagram of the Bluetooth dongle system according to another embodiment of the present invention. FIG. 4 includes a Bluetooth dongle 400, a Bluetooth earphone and a microphone 430 and a computer 420 with the internet access. In the present embodiment, a VOIP application and an auto-detecting program are stored in a storage unit 410 in the Bluetooth dongle 400. FIG. 5 is a schematic flowchart of the method of VOIP conversation using the Bluetooth earphone and the microphone according to another embodiment of the present invention. Referring to FIG. 4 and FIG. 5, the steps of the method for the VOIP conversation using the Bluetooth earphone and the microphone are described below.

First, a user plugs the Bluetooth dongle 400 in the USB port of the computer 420 (Step S500). The computer 420 automatically detects that a USB device has been plugged (Step S510). At this moment, the VOIP program stored in the Bluetooth dongle 400 is activated and executed automatically, and a wireless connection between the Bluetooth dongle 400 and the Bluetooth microphone 430 is also established (Step S520). Then, the cache files created during the execution of the VOIP program are pre-pointed to the storage unit 410 in the Bluetooth dongle 400 (Step S530). The VOIP program, for example, is an executable file that can be executed directly without additionally installing and removing the program manually.

Next, the auto-detecting program stored in the Bluetooth dongle 400 is activated (Step S540) to detect whether the Bluetooth dongle 400 is removed in every unit time period (Step S550). The unit time period may be set as one second, but not limited to it. After the VOIP program is activated, the user can begin the VOIP conversation through the Bluetooth earphone and the microphone 430 until the Bluetooth dongle 400 is removed by the user. When there is a need to sent/receive files while the VOIP program is running, for example, when the other party of the VOIP conversation wants to send files to the VOIP user, the files can be accessed through the storage unit 410 in the Bluetooth dongle 400.

If the auto-detecting program has not detected that the Bluetooth dongle 400 is removed, then the VOIP program and the auto-detecting program are continuously executed (Step S560), such that the user can continue the VOIP conversation. If the Bluetooth dongle 400 has been removed, then the connection between the Bluetooth dongle 400 and the Bluetooth earphone and microphone 430 is terminated (Step S570). The cache files stored in the storage unit 410 of the Bluetooth dongle 400 are removed (Step S580), and then the VOIP program and the auto-detecting program are closed (Step S590).

If the user wants to use the VOIP phone, he only needs to plug the Bluetooth dongle 400 in the computer 420, such that he can begin the voice conversation without executing and installing the program manually. If the user wants to end the conversation, he only needs to remove the Bluetooth dongle 400 to stop the conversation. After the conversation is ended, the cache files are removed automatically without leaving any record in the computer 420.

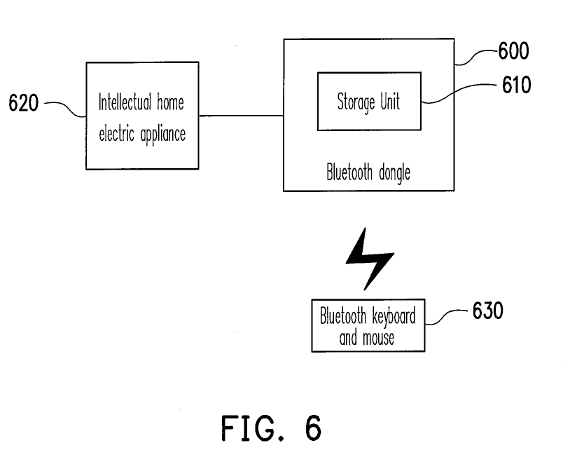

FIG. 6 is a schematic block diagram of the Bluetooth dongle system according to another embodiment of the present invention. FIG. 6 includes a Bluetooth dongle 600, a Bluetooth keyboard and the mouse 630 and an intellectual home appliance 620 with the internet access. In the present embodiment, the IM program and the auto-detecting program are stored in the storage unit 610 in the Bluetooth dongle 600.

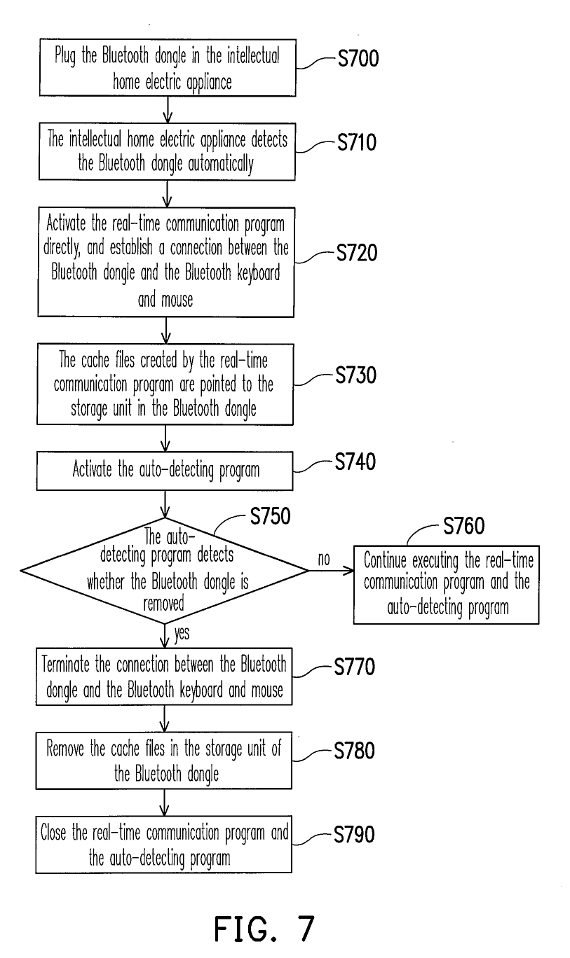

FIG. 7 is a schematic flowchart of the method of conducting the real-time communication using the Bluetooth keyboard and mouse according to another embodiment of the present invention. Referring to FIG. 6 and FIG. 7, the steps of the method of conducting the real-time communication using the Bluetooth keyboard and mouse are described below.

First, a user plugs the Bluetooth dongle 600 in the intellectual home electric appliance 620 (Step S700). The port being used, for example, is a USB port, but not limited to it. The intellectual home electric appliance 620 automatically detects that the Bluetooth dongle 600 has been plugged in (Step S710). In the mean time the Instant Messenger (IM) program stored in the Bluetooth dongle 600 is activated and executed, and the wireless connection between the Bluetooth dongle 600 and the Bluetooth keyboard and mouse 630 is also established (Step S720). The cache files created during the execution of the Instant Messenger (IM) are pre-pointed to the storage unit 610 in the Bluetooth dongle 600 (Step S730). The Instant Messenger (IM), for example, is an executable file that can be executed directly without additionally installing and removing the program manually.

Next, the auto-detecting program stored in the Bluetooth dongle 600 is activated (Step S740) to detect whether the Bluetooth dongle 600 is removed in every unit time period (Step S750). The the unit period may be set as one second, but not limited to it. After the Instant Messenger (IM) is activated, the user can begin the real-time communication through the Bluetooth keyboard and the microphone 630 until the Bluetooth dongle 600 is removed by the user. When there is a need to sent/receive a file while the IM is running, for example, when the other party conducting the real-time communication with the IM user wants to send files to the IM user, the files can be accessed through the storage unit 610 in the Bluetooth dongle 600.

If the auto-detecting program has not detected that the Bluetooth dongle 600 is removed, then the IM program and the auto-detecting program are continuously executed (Step S760), such that the user can continue the real-time communication. If the Bluetooth dongle 600 has been removed, then the connection between the Bluetooth dongle 600 and the Bluetooth keyboard and the mouse 630 is terminated (Step S770). The cache files in the storage unit 610 in the Bluetooth dongle 600 are removed (Step S780), and then the IM program and the auto-detecting program are closed (Step S790).

The features of the voice communication using the Bluetooth earphone and the microphone and features of the text communication using Bluetooth keyboard and the mouse are described in the above embodiments. However the present invention is not limited by the above embodiments. Users can perform the communications using different ways by combining different types of the Bluetooth devices according to the practical needs without departing from the scope of the present invention.

To sum up, the present invention provides the method of executing programs using the Bluetooth devices. When the Bluetooth dongle is plugged in the electronic device, the user can conduct the communication directly using the Bluetooth device without installing or executing the applications manually. In addition, the Bluetooth dongle can also be removed directly when the communication is finished. The cache files created during the execution of the applications can be pointed to the storage unit in the Bluetooth dongle without leaving any record in the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of executing program using a Bluetooth device, suitable for a bluetooth dongle with a USB, the method comprising the following steps:
plugging the Bluetooth dongle in a USB port of an electronic device, wherein the electronic device automatically dectects the bluetooth dongle after the bluetooth dongle is plugged in;
activating an application stored in a storage unit of the bluetooth dongle and activating the bluetooth dongle to link to a bluetooth device simultaneously;
pointing a cache file created by the application to the storage unit of the bluetooth dongle;
activating an auto-detecting program for detecting whether the bluetooth dongle is being removed after every predetermined time period, wherein if the bluetooth dongle has been removed, the link between the bluetooth dongle and the bluetooth device is terminated and the cache file stored in the storage unit of the bluetooth dongle is removed;
closing the application; and
closing the auto-detecting program.

2. The method of executing the program using the bluetooth device as claimed in claim 1, further comprising:
conducting a conversation through the bluetooth device after activating the application; and
ending the conversation when the bluetooth dongle is removed.

3. The method of executing the program using the bluetooth device as claimed in claim 2, wherein the application comprises a Voice Over IP (VOIP) program and an Instant Messenger (IM) program.

4. The method of executing the program using the bluetooth device as claimed in claim 2, wherein the bluetooth device comprises a bluetooth voice device, a bluetooth video device or a bluetooth input device.

5. The method of executing the program using the bluetooth device as claimed in claim 4, wherein the Bluetooth voice device comprises a bluetooth earphone and a bluetooth microphone.

6. The method of executing the program using the bluetooth device as claimed in claim 4, wherein the bluetooth input device comprises a bluetooth keyboard, a bluetooth mouse or a bluetooth personal digital organizer.

7. The method of executing the program using the bluetooth device as claimed in claim 1, further comprising:
accessing the file through the storage unit in the bluetooth dongle when the application needs to access a file.

8. The method of executing the program using the bluetooth device as claimed in claim 1, wherein the electronic device comprises a computer device, an intellectual home electric appliance or a personal digital organizer.

9. The method of executing the program using the bluetooth device as claimed in claim 1, wherein the application is coded using a Green Software.

10. The method of executing the program using the bluetooth device as claimed in claim 1, wherein the predetermined time period comprises one second.

11. The method of executing the programs using the Bluetooth device as claimed in claim 1, wherein the storage unit comprises a hard drive or a memory.
